(19) United States
(12) Patent Application Publication
(10) Pub. No.: US 2025/0233168 A1
(43) Pub. Date: Jul. 17, 2025

(54) FUEL CELL STACK

(71) Applicant: Honda Motor Co., Ltd., Tokyo (JP)

(72) Inventors: Fumiya Arai, Wako-shi (JP); Shohei Toyota, Wako-shi (JP)

(21) Appl. No.: 19/001,495

(22) Filed: Dec. 25, 2024

(30) Foreign Application Priority Data
Jan. 17, 2024 (JP) 2024-005005

(51) Int. Cl. H01M 8/0247; H01M 8/04082; H01M 8/10; H01M 8/1004; H01M 8/241; H01M 8/2457

(52) U.S. Cl. CPC H01M 8/0247; H01M 8/04201; H01M 8/1004; H01M 8/241; H01M 8/2457; H01M 2008/1095

(57) ABSTRACT

A fuel cell stack including a cell stacked body having multiple power generation cells and a dummy cell disposed adjacent to an end power generation cell among the power generation cells, and an end unit disposed adjacent to the dummy cell. A gas supply port communicating with a gas supply flow path and a gas discharge port communicating with a gas discharge flow path are provided at the end unit, the gas supply flow path is configured by multiple communication holes including a first and second communication hole provided at the end power generation cell and the dummy cell, and the first and second communication hole are arranged such that an extension surface formed by extending an opening surface of the second communication hole in the predetermined direction toward the first communication hole is misaligned with an opening surface of the first communication hole.

### CROSS-REFERENCE TO RELATED APPLICATION

This application is based upon and claims the benefit of priority from Japanese Patent Application No. 2024-005005 filed on Jan. 17, 2024, the content of which is incorporated herein by reference.

### BACKGROUND OF THE INVENTION

### Field of the Invention

This invention relates to a fuel cell stack.

### Description of the Related Art

In recent years, technological developments have been made on a fuel cell that contribute to energy efficiency in order to ensure access to energy that is affordable, reliable, sustainable and advanced by more people. As a conventional technology related to this type of a fuel cell, a fuel cell stack is known in which a dummy cell is placed on the dry side of the fuel cell stack, and liquid water contained in the fuel gas supplied through the fuel gas supply passage is separated from the fuel gas on the downstream side of the dummy cell. Such a fuel cell stack is described, for example, in Japanese Unexamined Patent Publication No. 2022-165808 (JP 2022-165808 A).

However, in the fuel cell stack described in JP 2022-165808 A, there is a risk that the liquid water contained in the fuel gas is separated in the fuel gas supply passage before reaching the dummy cell on the dry side and flows into the power generation cell, potentially destabilizing the power generation performance.

### SUMMARY OF THE INVENTION

An aspect of the present invention is a fuel cell stack including: a cell stacked body including a plurality of power generation cells stacked in a predetermined direction, a dummy cell, a gas supply flow path into which a reaction gas is supplied, a gas discharge flow path through which the reaction gas is discharged, and a gas flow path communicating the gas supply flow path and the gas discharge flow path, the plurality of power generation cells including an end power generation cell disposed at an end in the predetermined direction, each of the plurality of power generation cells being a power generation element, the dummy cell being disposed adjacent to the end power generation cell and being a non-power generation element, the gas supply flow path and the gas discharge flow path extending along the predetermined direction; and an end unit disposed adjacent to the dummy cell. A gas supply port communicating with the gas supply flow path and a gas discharge port communicating with the gas discharge flow path are provided at the end unit, the gas supply flow path is configured by a plurality of communication holes including a first communication hole provided at the end power generation cell and a second communication hole provided at the dummy cell, and the first communication hole and the second communication hole are arranged such that an extension surface formed by extending an opening surface of the second communication hole in the predetermined direction toward the first communication hole is misaligned with an opening surface of the first communication hole.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack according to an embodiment of the present invention;

FIG. 2 is a cross-sectional view taken along line II-II in FIG. 1;

FIG. 3 is a perspective view showing a schematic configuration of a unitized electrode assembly included in the fuel cell stack of FIG. 1;

FIG. 4 is a rear view of a separator in FIG. 1;

FIG. 5 is a cross-sectional view taken along line v-v in FIG. 1;

FIG. 6A is a cross-sectional view taken along line A-A in FIG. 4;

FIG. 6B is a cross-sectional view taken along line B-B in FIG. 4;

FIG. 7A is a cross-sectional view schematically illustrating a configuration of a first liquid water inflow suppressing portion provided in the fuel cell stack according to the embodiment of the present invention;

FIG. 7B is a view taken along an arrow VIIB of FIG. 7A;

FIG. 8 is a cross-sectional view schematically illustrating a configuration of a second liquid water inflow suppressing portion provided in the fuel cell stack according to the embodiment of the present invention;

FIG. 9A is a cross-sectional view schematically illustrating a configuration of a third liquid water inflow suppressing portion provided in the fuel cell stack according to the embodiment of the present invention;

FIG. 9B is a view taken along an arrow IXB of FIG. 9A; and

FIG. 10 is a cross-sectional view illustrating a modification of a through-hole of a gas supply flow path provided in an end unit.

### DETAILED DESCRIPTION OF THE INVENTION

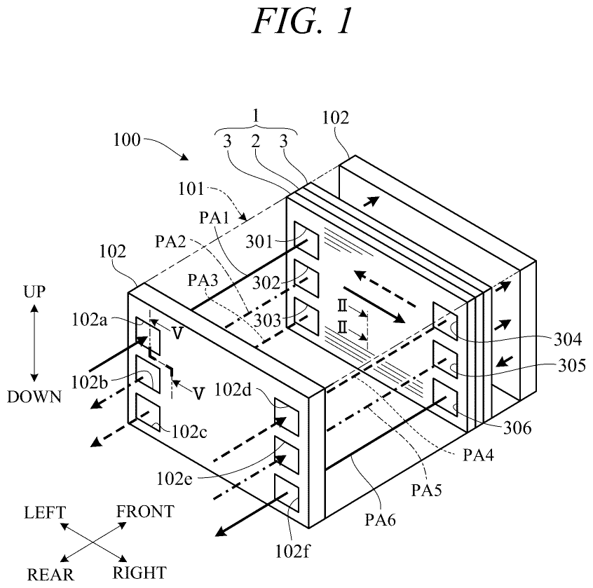

Hereinafter, an embodiment of the present invention will be described with reference to FIGS. 1 to 10. A fuel cell stack according to an embodiment of the present invention is a main component of a fuel cell. The fuel cell is mounted on, for example, a vehicle and can generate electric power for driving the vehicle. First, an overall configuration of the fuel cell stack will be schematically described.

FIG. 1 is a perspective view schematically showing an overall configuration of a fuel cell stack 100 according to the embodiment of the present invention. Hereinafter, for the sake of convenience, three-axis directions orthogonal to each other as illustrated in the drawing are defined as a front-rear direction, a left-right direction, and an up-down direction, and a configuration of each part will be described according to such definitions. The downward direction in the up-down direction corresponds to the direction of gravity, for example. The front-rear direction corresponds to the stacking direction of the fuel cell stack 100. The front-rear direction and left-right direction are not necessarily the same as the front-rear direction and left-right direction of the vehicle. For example, the front-rear direction in FIG. 1 may be the front-rear direction of the vehicle or the left-right direction of the vehicle.

As shown in FIG. 1, the fuel cell stack 100 has a cell stacked body 101 formed by stacking a plurality of power generation cells 1 in the front-rear direction, and end units 102 arranged at both front and rear ends of the cell stacked body 101, and the whole of the fuel cell stack 100 has a substantially rectangular parallelepiped shape. Although not shown, the periphery of the cell stacked body 101 is covered by a substantially rectangular parallelepiped-shaped case. The length of the cell stacked body 101 in the left-right direction is longer than its length in the up-down direction. For convenience, a single power generation cell 1 is shown in FIG. 1.

The power generation cell 1 has a unitized electrode assembly (hereinafter, referred to as a “UEA”) 2 including a membrane electrode assembly that includes an electrolyte membrane and electrodes, and separators 3 and 3 arranged on both front and rear sides of the UEA 2 to sandwich the UEA 2. The UEA 2 and the separator 3 are alternately arranged in the front-rear direction. The UEA 2 can also be referred to as a membrane electrode structure or a membrane electrode member.

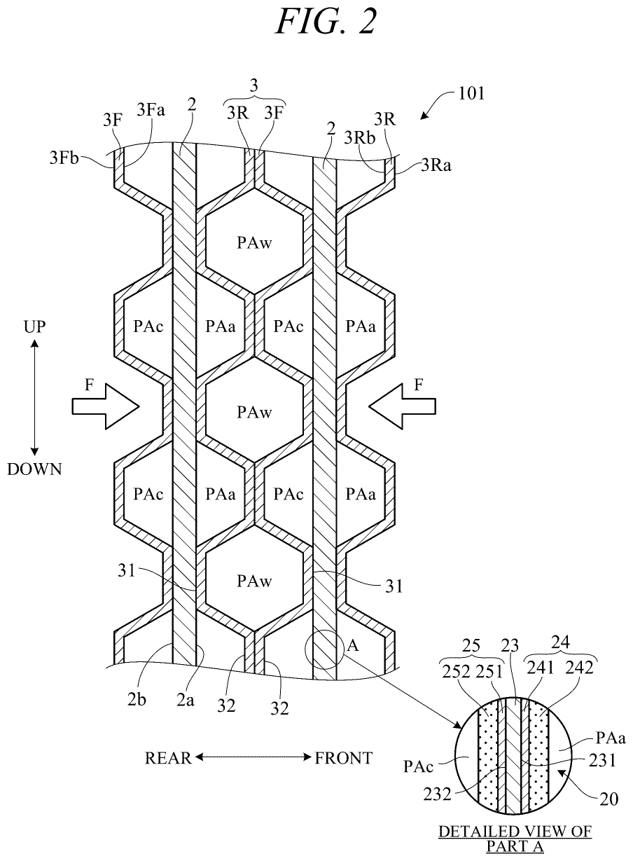

FIG. 2 is a cross-sectional view (along line II-II in FIG. 1) of the central part in the left-right direction of the cell stacked body 101. As shown in FIG. 2, the separator 3 has a front plate 3F and a rear plate 3R, which are a pair of metal thin plates with a corrugated cross-section. The front plate 3F extends in the up-down and left-right directions and has a front surface 3Fa and a rear surface 3Fb. The rear plate 3R extends in the up-down, and left-right directions, and has a front surface 3Ra and a rear surface 3Rb. The rear surface 3Fb of the front plate 3F and the front surface 3Ra of the rear plate 3R facing each other are joined together by welding or the like at their outer peripheral edges. Thus, the front plate 3F and the rear plate 3R are integrally joined. The separator 3 uses a conductive material with excellent corrosion resistance, such as stainless steel, titanium, or titanium alloy.

Inside the separator 3 enclosed by the front plate 3F and the rear plate 3R, that is, between the rear surface 3Fb of the front plate 3F and the front surface 3Ra of the rear plate 3R, a cooling flow path PAw through which a cooling medium flows is formed. The generating surface of the power generation cell 1 is cooled by the flow of the cooling medium. Water, for example, can be used as the cooling medium. The surface of the separator 3 (front surface 3Fa and rear surface 3Rb) facing the UEA 2 is formed into an uneven shape by press molding or the like to form a gas flow path between the UEA 2 and the separator 3. More specifically, the separator 3 has a pair of front and rear protrusions 31 and 31 protruding towards the UEA 2, and a pair of front and rear resessed portions 32 and 32.

The pair of front and rear protrusions 31 and 31 abut the front surface 2a and the rear surface 2b of the UEA 2. In the cell stacked body 101, a compressive load F is applied in the front-rear direction during the assembly of the fuel cell stack 100, and this compressive load F is maintained after the assembly of the fuel cell stack 100 is completed. Therefore, a predetermined surface pressure due to the compressive load F acts in the front-rear direction on the UEA 2 through the protrusions 31.

Between the front surface 2a of the UEA 2 and the rear plate 3R of the separator 3 facing this front surface 2a, an anode flow path PAa through which fuel gas (anode gas) flows is formed by the recessed portions 32. Between the rear surface 2b of the UEA 2 and the front plate 3F of the separator 3 facing this rear surface 2b, a cathode flow path PAc through which oxidant gas (cathode gas) flows is formed by the recessed portions 32. The fuel gas is a gas containing hydrogen, and hydrogen gas can be used, for example. The oxidant gas is a gas containing oxygen, and air can be used, for example. The fuel gas and the oxidant gas may collectively be referred to as a reaction gas without distinguishing between them.

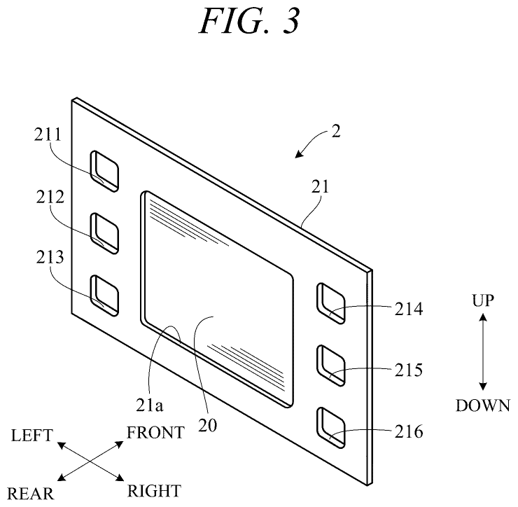

FIG. 3 is a perspective view showing a schematic configuration of the UEA 2. As shown in FIG. 3, the UEA 2 includes a substantially rectangular membrane electrode assembly (hereinafter, referred to as a “MEA”) 20 and a frame 21 that supports the MEA 20. As shown in the detailed view of part “A” in FIG. 2, the MEA 20 has an electrolyte membrane 23, an anode electrode 24 provided on a front surface 231 of the electrolyte membrane 23, and a cathode electrode 25 provided on a rear surface 232 of the electrolyte membrane 23.

The electrolyte membrane 23 is, for example, a solid polymer electrolyte membrane, and a thin film of perfluorosulfonic acid polymer containing moisture can be used. Not only a fluorine-based electrolyte but also a hydrocarbon-based electrolyte can be used.

The anode electrode 24 has an electrode catalyst layer 241 formed on the front surface 231 of the electrolyte membrane 23 and served as a reaction field for electrode reaction, and a gas diffusion layer 242 formed on the front surface of the electrode catalyst layer 241 to spread and supply the fuel gas. An intermediate layer (underlayer) can also be provided between the electrode catalyst layer 241 and the gas diffusion layer 242.

The cathode electrode 25 has an electrode catalyst layer 251 formed on the rear surface 232 of the electrolyte membrane 23 and served as a reaction field for electrode reaction, and a gas diffusion layer 252 formed on the rear surface of the electrode catalyst layer 251 to spread and supply the oxidant gas. An intermediate layer (underlayer) can also be provided between the electrode catalyst layer 251 and the gas diffusion layer 252.

In the anode electrode 24, the fuel gas (hydrogen) supplied through the anode flow path PAa is ionized by an action of a catalyst, passes through the electrolyte membrane 23, and moves to the cathode electrode side. Electrons generated at this time pass through an external circuit and are extracted as electric energy. In the cathode electrode 25, an oxidant gas (oxygen) supplied via the cathode flow path PAc reacts with hydrogen ions guided from the anode electrode 24 and electrons moved from the anode electrode 24 to generate water. The generated water gives an appropriate humidity to the electrolyte membrane 23, and excess water is discharged to an outside of the UEA 2 along the gas flow. The generated water on the cathode side also flows to the anode side by inverse spread through the electrolyte membrane 23. Therefore, the generated water is present in both the anode flow path PAa and the cathode flow path PAc.

As shown in FIG. 3, the frame 21 is a thin plate having a substantially rectangular shape, and is made of an insulating resin, rubber, or the like. A substantially rectangular opening 21a is provided in a central portion of the frame 21. The MEA 20 is disposed to cover the entire opening 21a and a peripheral portion of the MEA 20 is supported by the frame 21.

Three through-holes 211 to 213 penetrating the frame 21 in the front-rear direction are opened side by side in the up-down direction on the left side of the opening 21a of the frame 21. Three through-holes 214 to 216 penetrating the frame 21 in the front-rear direction are opened side by side in the up-down direction on the right side of the opening 21a of the frame 21. For convenience, the through-holes 211 to 216 are all shown as having a substantially rectangular shape, but the shape and arrangement of the through-holes 211 to 216 are not limited to this.

As shown in FIG. 1, in the separator 3 in front of and behind the UEA 2, through-holes 301 to 306 penetrating the separators 3 in the front-rear direction are opened at positions corresponding to the through-holes 211 to 216 of the frame 21. The through-holes 301 to 306 communicate with the through-holes 211 to 216 of the frame 21, respectively. The set of the through-holes 211 to 216 and 301 to 306 communicating with each other forms flow paths PA1 to PA6 (indicated by arrows for the sake of convenience) penetrating the cell stacked body 101 and extending in the front-rear direction. The flow paths PA1 to PA6 may be referred to as manifolds. The flow paths PA1 to PA6 are connected to a manifold outside the fuel cell stack 100.

Although not shown, the end units 102 in front of and behind the cell stacked body 101 each has a plurality of plates arranged in the front-rear direction. That is, the end unit 102 includes a terminal plate disposed adjacent to the cell stacked body 101, an insulating plate disposed outside the terminal plate in the front-rear direction, and an end plate disposed outside the insulating plate in the front-rear direction.

The terminal plate is a substantially rectangular plate-shaped member made of metal, and has a terminal portion for extracting electric power generated by an electrochemical reaction in the cell stacked body 101. The insulating plate is a substantially rectangular plate-shaped member made of non-conductive resin or rubber, and electrically insulates the terminal plate from the end plate. The end plate 6 is a plate-shaped member made of metal or resin having high strength.

The rear end unit 102 is a wet-side end unit through which the reaction gas and cooling medium pass, while the front end unit 102 is a dry-side end unit through which the reaction gas and cooling medium do not pass. In the rear end unit 102, a plurality of through-holes 102a to 102f are opened at positions corresponding to the through-holes 211 to 216 and 301 to 306 of the cell stacked body 101, so as to penetrate the end unit 102 in the front-rear direction. The through-holes 102a to 102f are shown as approximately rectangular for convenience, but the shapes of the through-holes 102a to 102f are not limited to this.

A fuel gas tank storing high-pressure fuel gas is connected to the through-hole 102a via an ejector, an injector, etc., and the fuel gas (anode gas) is supplied to the fuel cell stack 100 through the through-hole 102a along a flow path PA1 shown by the solid line. This fuel gas is guided to the anode flow path PAa between the UEA 2 and the rear plate 3R of the separator 3 through the through-holes 211 and 301. The fuel gas after passing through the anode flow path PAa, i.e., the fuel exhaust gas (anode off-gas), is discharged from the through-hole 102f through the through-holes 216 and 306 along a flow path PA6 shown by the solid line. The through-hole 102a is provided on the upper side in the up-down direction (opposite to the direction of gravity) compared to the through-hole 102f.

A compressor for supplying oxidant gas is connected to the through-hole 102d, and the oxidant gas (cathode gas) compressed by the compressor is supplied to the fuel cell stack 100 through the through-hole 102d along a flow path PA4 shown by the dotted line. This oxidant gas is guided to the cathode flow path PAc between the UEA2 and the front plate 3F of the separator 3 through the through-holes 214 and 304. The oxidant gas after passing through the cathode flow path PAc, i.e., the oxidant exhaust gas (cathode off-gas), is discharged from the through-hole 102c through the through-holes 213 and 303 along a flow path PA3 shown by the dotted line.

A pump for supplying cooling medium is connected to the through-hole 102e, and the cooling medium is supplied to the fuel cell stack 100 through the through-hole 102e along a flow path PA5 shown by the one-dot chain line. This cooling medium is guided to the cooling flow path PAw between the front plate 3F and the rear plate 3R of the separator 3 through the through-holes 215 and 305. The cooling medium after passing through the cooling flow path PAw is discharged from the through-hole 102b through the through-holes 212 and 302 along a flow path PA2 shown by the one-dot chain line. The discharged cooling medium is cooled by heat exchange in the radiator, and is supplied again to the fuel cell stack 100 through the through-hole 102e. The above is the schematic configuration of the fuel cell stack 100.

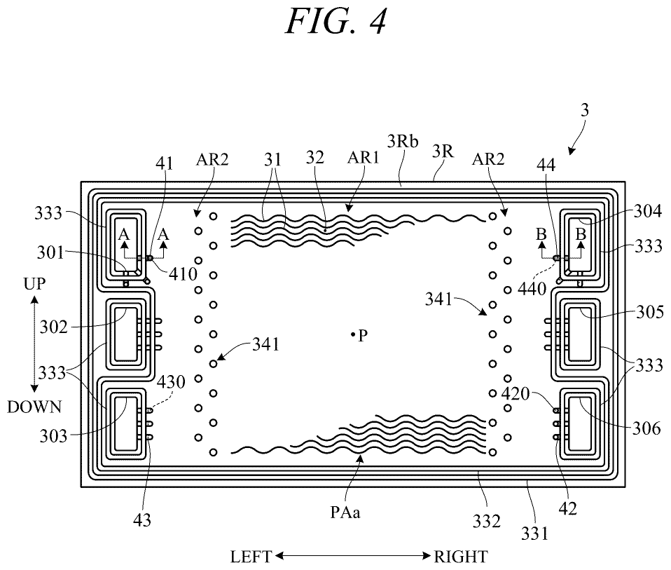

The configuration of the separator 3 will be described in more detail. FIG. 4 is a rear view (a view viewed from the rear) of the separator 3. That is, FIG. 4 is a view illustrating a rear surface 3Rb (FIG. 2) of the separator 3 facing an anode electrode 24 on a front surface 2a of the UEA 2. A point “P” in the drawing is an intermediate point in the left-right direction and an intermediate point in the up-down direction of the separator 3, and is referred to as a center point. The left-right direction and the up-down direction in FIG. 4 correspond to a longitudinal direction and a transverse direction of the separator 3, respectively.

In FIG. 4, a region facing the MEA 20 of the UEA 2, that is, a region AR1 facing the power generation surface is referred to as an active region of the separator 3, and a region AR2 other than the active region is referred to as an inactive region. As illustrated in FIGS. 2 and 4, in the active region AR1 of the separator 3, a plurality of protrusions 31 (FIG. 2) are provided to protrude rearward at equal intervals in the up-down direction over substantially the entire area although a part thereof is not illustrated. Each of the plurality of protrusions 31 extends in the left-right direction while meandering, and a recessed portion 32 (FIG. 2) is provided between the protrusions 31 and 31 adjacent in the up-down direction. The anode flow path PAa is formed between the plurality of recessed portions 32 and the front surface 2a of the MEA 20.

As illustrated in FIG. 4, the rear surface 3Rb of the separator 3 (rear plate 3R) is provided with a plurality of sealing bead portions protruding rearward toward a frame 21, that is, metal bead seals. The plurality of bead portions include an outer bead portion 331, an inner bead portion 332, and an end bead portion 333.

The outer bead portion 331 extends along the peripheral edge of the rear plate 3R so as to surround the entire through-holes 301 to 306, and has a substantially rectangular shape as a whole. The end bead portions 333 are provided by the number of the through-holes 301 to 306. The plurality of end bead portions 333 each have a substantially rectangular shape and individually surround the plurality of through-holes 301 to 306. The inner bead portion 332 is provided inside the outer bead portion 331. More specifically, the inner bead portion 332 extends in a zigzag shape via the outside in the left-right direction of the end bead portions 333 around the through-holes 301, 303, 304, and 306 and via the inside in the left-right direction of the end bead portions 333 around the through-holes 302 and 305. The end bead portions 333 around the through-holes 302 and 305 are positioned between the outer bead portion 331 and the inner bead portion 332.

A plurality of substantially cylindrical embossed portions 341 protruding in a front-rear direction are provided on both sides of the active region AR1 of the separator 3 in the left-right direction. The protrusion 31, the recessed portion 32, the metal bead seal, and the like are formed by pressing the rear plate 3R.

Although not illustrated, a plurality of protrusions 31, recessed portions 32, metal bead seals (the outer bead portion 331, the inner bead portion 332, and the end bead portions 333), and the like are similarly formed also on the front surface 3Fa of the separator 3 (front plate 3F) by pressing the front plate 3F. Accordingly, the cathode flow path PAc is formed between the plurality of recessed portions 32 and the rear surface 2b of the MEA 20.

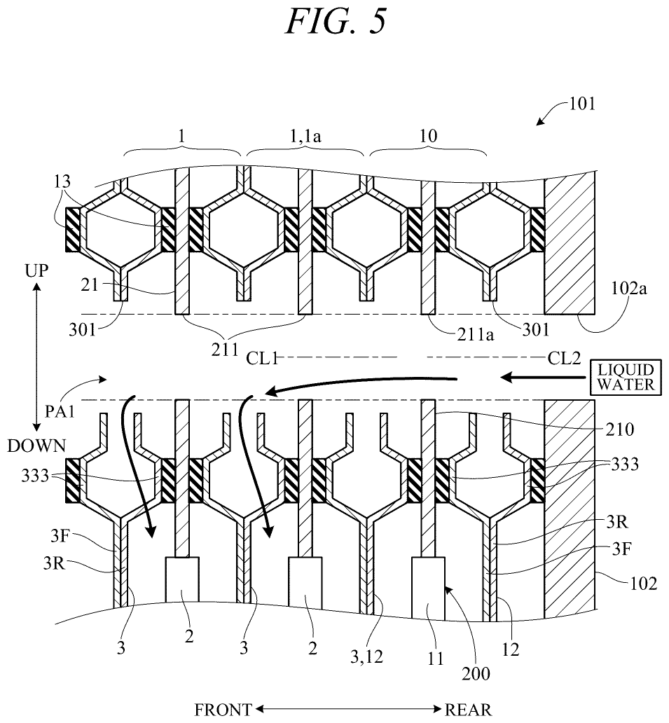

FIG. 5 is a cross-sectional view of a main part of a rear end portion of the fuel cell stack 100 including the flow path PA1 for supplying the fuel gas in FIG. 1 (a cross-sectional view taken along line V-V in FIG. 1). As illustrated in FIG. 5, the cell stacked body 101 includes a plurality of power generation cells 1 that are power generation elements and a dummy cell 10 that is non-power generation element. The dummy cell 10 is interposed between a rearmost power generation cell 1 (for convenience, referred to as a rear end power generation cell 1a) and the rear end unit 102. The dummy cell 10 can also be interposed between a foremost power generation cell 1 and the front end unit 102.

The dummy cell 10 includes a dummy assembly 11 corresponding to the UEA 2 and dummy separators 12 arranged on both sides of the dummy assembly 11 in the front-rear direction. The configuration of the dummy separator 12 is the same as the configuration of the separator 3 of the power generation cell 1. Therefore, the through-holes 301 to 306 having the same configuration as the separator 3 are opened in the dummy separator 12.

The dummy assembly 11 includes a dummy frame 210 and a dummy joint body 200. The dummy frame 210 is configured similarly to the frame 21 of the power generation cell 1 except that through-holes 211 and 214 for supplying the reaction gas are different in configuration (size). Therefore, similarly to the through-holes 211 to 216 and an opening 21a of the frame 21, through-holes 211a to 216a and the opening 21a are opened in the dummy frame 210.

The dummy joint body 200 is a joint of a conductive plate and an electrode, provided so as to cover the opening 21a (FIG. 3) of the dummy frame 210. The dummy cell 10 is different from the power generation cell 1 in not including the electrolyte membrane 23, and power generation is not performed in the dummy cell 10. By arranging the dummy cell 10 adjacent to the end unit 102 in this manner, the dummy cell 10 functions as a heat insulating layer, and a decrease in temperature of the power generation cell 1 can be suppressed. Instead of separately providing the dummy frame 210 and the dummy joint body 200, the plate of the dummy joint body 200 may be increased in size so that the plate of the dummy joint body 200 has a function as the dummy frame 210. In FIG. 5, the single dummy cell 10 is arranged between the power generation cell 1 and the end unit 102, but a plurality of dummy cells 10 may be arranged.

FIG. 5 illustrates sealing bead portions (end bead portions 333) protruding forward and rearward from the front plate 3F and the rear plate 3R of the separator 3 and the dummy separator 12, respectively. A sealing material 13 made of a constituent material having elasticity such as rubber or a resin material is fixed to the surface of the end bead portion 333. Although not illustrated, the sealing material 13 is fixed not only to the surface of the end bead portion 333 but also to the surfaces of the outer bead portion 331 (FIG. 4) and the inner bead portion 332 (FIG. 4). A pressing force in the front-rear direction is applied to the sealing material 13, whereby a contact surface between the separator 3 and the frame 21 and a contact surface between the dummy separator 12, and the dummy frame 210 and the end unit 102 can be sealed.

As illustrated in FIG. 4, a plurality of tunnel portions 41 are provided in the end bead portion 333 around the through-hole 301 of the separator 3 for inflow of the fuel gas, so as to cross the end bead portion 333. For example, the tunnel portion 41 is provided so as to cross the right end portion of the end bead portion 333 in the left-right direction and cross the lower end portion of the end bead portion 333 in the up-down direction.

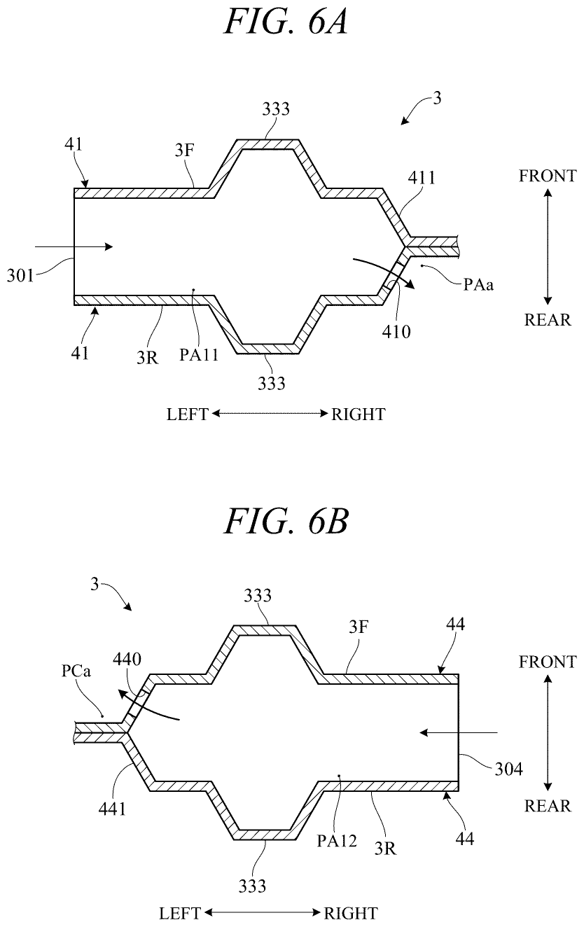

FIG. 6A is a cross-sectional view (a cross-sectional view taken along line A-A in FIG. 4) illustrating the configuration of the tunnel portion 41 in the vicinity of the through-hole 301. As illustrated in FIG. 6A, the tunnel portion 41 is provided on the front plate 3F so as to protrude forward, and the tunnel portion 41 is provided on the rear plate 3R so as to protrude rearward. The amount of protrusion of the tunnel portion 41 in the front-rear direction is smaller than the amount of protrusion of the bead portion 333 in the front-rear direction. Although not illustrated, the tunnel portion 41 has a substantially rectangular or trapezoidal cross section, and a communication flow path PA11 is formed between the front and rear tunnel portions 41 and 41.

The left end of the tunnel portion 41 is positioned at the peripheral edge of the through-hole 301, and the left end of the communication flow path PA11 is opened to face the through-hole 301. A tapered portion 411 of which the protrusion amount gradually decreases toward the right side is provided at the right end portion of the tunnel portion 41 on the right side of the end bead portion 333. At the right end of the tunnel portion 41, the protrusion amount in the front-rear direction becomes 0, and the communication flow path PA11 is closed. A outlet 410 for fuel gas is opened in the tapered portion 411 of the rear plate 3R. Accordingly, the through-hole 301 and the anode flow path PAa behind the rear plate 3R communicate with each other via the communication flow path PA11 and the outlet 410. For this reason, the fuel gas flowing through the through-hole 301 can be supplied to the anode flow path PAa via the communication flow path PA11 and the outlet 410 as indicated by arrows in FIG. 6A.

As illustrated in FIG. 4, a plurality of tunnel portions 42 are provided in the end bead portion 333 around the through-hole 306 of the separator 3 so as to cross the end bead portion 333. Although not illustrated, the tunnel portion 42 is configured similarly to the tunnel portion 41 in FIG. 6A. That is, the tunnel portion 41 and the tunnel portion 42 have a symmetrical shape or a substantially symmetrical shape with respect to an axis (not illustrated) extending in the front-rear direction through the center point P in FIG. 4. Therefore, a inlet 420 for fuel gas is opened in the tapered portion at the left end portion of the tunnel portion 42 of the rear plate 3R. Accordingly, the fuel gas flowing through the anode flow path PAa is guided to the through-hole 306 via the inlet 420 and the communication flow path PA11 inside the tunnel portion 42.

A plurality of tunnel portions 44 are provided also in the end bead portion 333 around the through-hole 304 of the separator 3 for inflow of the oxidant gas, so as to cross the end bead portion 333. For example, the tunnel portion 44 is provided so as to cross the left end portion of the end bead portion 333 in the left-right direction and cross the lower end portion of the end bead portion 333 in the up-down direction.

FIG. 6B is a cross-sectional view (a cross-sectional view taken along line B-B in FIG. 4) illustrating the configuration of the tunnel portion 44 in the vicinity of the through-hole 304. As illustrated in FIG. 6B, the tunnel portion 44 is provided on the front plate 3F so as to protrude forward, and the tunnel portion 44 is provided on the rear plate 3R so as to protrude rearward. The amount of protrusion of the tunnel portion 44 in the front-rear direction is smaller than the amount of protrusion of the bead portion 333 in the front-rear direction. Although not illustrated, the tunnel portion 44 has a substantially rectangular or trapezoidal cross section, and a communication flow path PA12 is formed between the front and rear tunnel portions 44 and 44.

The right end of the tunnel portion 44 is positioned at the peripheral edge of the through-hole 304, and the right end of the communication flow path PA12 is opened to face the through-hole 304. A tapered portion 441 of which the protrusion amount gradually decreases toward the left side is provided at the left end portion of the tunnel portion 44 on the left side of the end bead portion 333. At the left end of the tunnel portion 44, the protrusion amount in the front-rear direction becomes 0, and the communication flow path PA12 is closed. An outlet 440 for the oxidant gas is opened in the tapered portion 441 of the front plate 3F. Accordingly, the through-hole 304 and the cathode flow path PAc in front of the front plate 3F communicate with each other via the communication flow path PA12 and the outlet 440. For this reason, the oxidant gas flowing through the through-hole 304 can be supplied to the cathode flow path PAc via the communication flow path PA12 and the outlet 440 as indicated by arrows in FIG. 6B.

As illustrated in FIG. 4, a plurality of tunnel portions 43 are provided in the end bead portion 333 around the through-hole 303 of the separator 3 so as to cross the end bead portion 333. Although not illustrated, the tunnel portion 43 is configured similarly to the tunnel portion 44 in FIG. 6B. That is, the tunnel portion 43 and the tunnel portion 44 have a symmetrical shape or a substantially symmetrical shape with respect to an axis (not illustrated) extending in the front-rear direction through the center point P in FIG. 4. Therefore, a inlet 430 for fuel gas is opened in the tapered portion at the right end portion of the tunnel portion 43 of the front plate 3F. Accordingly, the oxidant gas flowing through the cathode flow path PAc is guided to the through-hole 303 via the inlet 430 and the communication flow path PA12 inside the tunnel portion 43.

The configurations (the number, the positions, the shapes, and the like) of the tunnel portions 41 and 44 communicating the flow paths PA1 and PA4 for gas supply with the anode flow path PAa and the cathode flow path PAc and the tunnel portions 42 and 43 communicating the flow paths PA3 and PA6 for gas discharge with the anode flow path PAa and the cathode flow path PAc are not limited to those described above. For example, more tunnel portions 41 and 44 may be provided downward or obliquely downward.

As illustrated in FIG. 5, an axis CL1 passing through the center of the through-hole 211 of the frame 21 in the up-down direction and the left-right direction and an axis CL2 passing through the center of the through-hole 211a of the dummy frame 210 in the up-down direction and the left-right direction are positioned on the same straight line extending in the front-rear direction. The through-holes 211 and 211a of the frame 21 and the dummy frame 210 are smaller than the through-holes 301 of the separator 3 and the dummy separator 12. For this reason, the frame 21 and the dummy frame 210 protrude inward (axes CL1 and CL2 side) from the separator 3 and the dummy separator 12.

In FIG. 5, for convenience, the through-hole 211 and the through-hole 211a are illustrated in the same shape and size. The same size means that the opening areas of the through-holes 211 and 211a are the same. In FIG. 5, the axes CL1 and CL2 are on the same straight line, and the shapes of the through-holes 211 and 211a are the same. Therefore, an extension surface obtained by extending the opening surface along the edge of the through-hole 211a (inner peripheral surface of the through-hole 211a) forward coincides with the opening surface of the through-hole 211 (inner peripheral surface of the through-hole 211).

When the through-hole 211a of dummy cell 10 (dummy frame 210) and the through-hole 211 of the power generation cell 1 (frame 21) are set to have the same shape and size as described above, the following problem arises. That is, in this case, liquid water (generated water or condensed water) having flowed into the cell stacked body 101 together with the fuel gas through the through-hole 102a of the end unit 102 may jump over the through-hole 211a of the dummy cell 10 to reach the power generation cell 1 as indicated by arrows in FIG. 5.

The liquid water that has reached the power generation cell 1 is guided to the anode flow path PAa facing the power generation surface of the UEA 2 along the flow of the fuel gas via the communication flow path PA11 (FIG. 6A) inside the tunnel portion 41. As a result, an electrochemical reaction on the power generation surface is inhibited, and there is a possibility that a power generation performance becomes unstable and the power generation performance is deteriorated. This similarly becomes a problem not only in the flow path PA1 for supplying the fuel gas but also in the flow path PA4 (FIG. 1) for supplying the oxidant gas. That is, the liquid water in the flow path PA4 is guided to the cathode flow path PAc facing the power generation surface of the UEA 2 along the flow of the oxidant gas via the communication flow path PA12 (FIG. 6B) inside the tunnel portion 44, and there is a possibility that the power generation performance becomes unstable and the power generation performance is deteriorated.

In this regard, in order to obtain stable power generation performance by providing a liquid water inflow suppressing portion for suppressing the liquid water having flowed into the flow paths PA1 and PA4 from being guided to the power generation surface, the present embodiment configures the fuel cell stack 100 as follows.

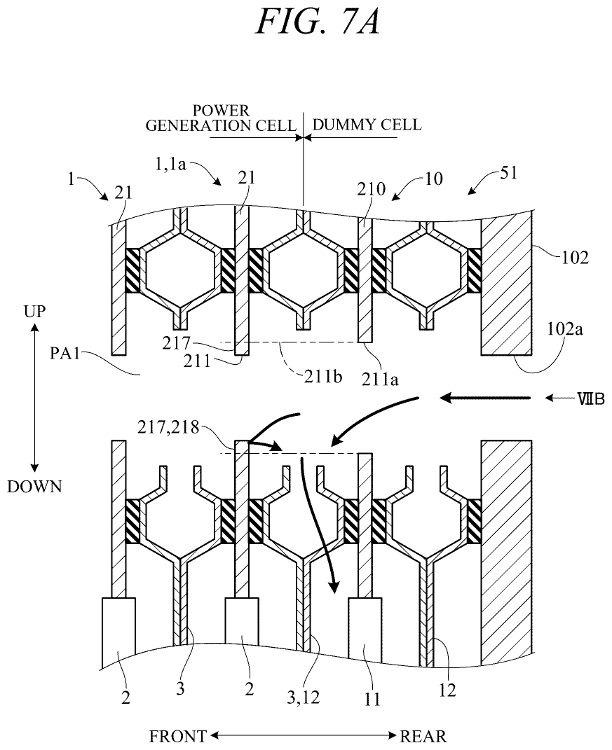

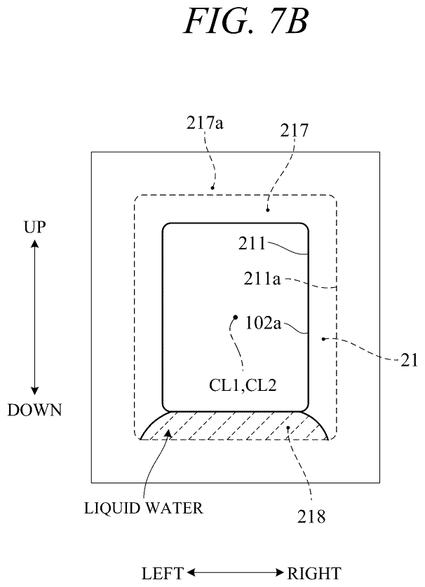

FIG. 7A is a view schematically illustrating a first example of the liquid water inflow suppressing portion, that is, a configuration of a first liquid water inflow suppressing portion 51, and is a cross-sectional view including the flow path PA1 for supplying the fuel gas, similarly to FIG. 5. FIG. 7B is a view (a view taken along an arrow VIIB of FIG. 7A) of the flow path PA1 when viewed from the rear. Although not illustrated, the first liquid water inflow suppressing portion 51 is similarly provided in the flow path PA4 for supplying the oxidant gas.

As illustrated in FIGS. 7A and 7B, in the first liquid water inflow suppressing portion 51, the through-hole 211a of the dummy frame 210 is formed to be larger than the through-hole 211 of the frame 21 and larger (particularly larger in the up-down direction) than the through-hole 102a of the end unit 102. The through-hole 211 of the frame 21 and the through-hole 102a of the end unit 102 are the same size. The axis CL1 (FIG. 5) of the through-hole 211 and the axis CL2 (FIG. 5) of the through-hole 211a are positioned on the same straight line.

In the first liquid water inflow suppressing portion 51, an edge portion 217 of the through-hole 211 of the frame 21 protrudes inward over the entire circumference of an edge portion 217a of the through-hole 211a of the dummy frame 210. For this reason, an extension surface 211b (two-dot chain line) obtained by extending the opening surface of through-hole 211a forward is positioned outside the opening surface of through-hole 211 (on the opposite side of the axes CL1 and CL2), and the extension surface 211b abuts on the frame 21 of the rear end power generation cell 1a. The edge portion 217 of the through-hole 211 of the frame 21 constitutes a protrusion portion protruding inward from the through-hole 211a. The protrusion portion on the lower side is particularly referred to as a lower protrusion portion 218.

The first liquid water inflow suppressing portion 51 operates as follows. When the liquid water flows into the flow path PA1 through the through-hole 102a of the end unit 102, a part of the liquid water having passed through the through-hole 211a of the dummy frame 210 collides with the edge portion 217 (protrusion portion) of the through-hole 211 as indicated by an arrow in FIG. 7A. More specifically, the liquid water easily generates a downward flow by gravity, and thus a part of the liquid water having passed through the through-hole 211a collides with the lower protrusion portion 218. For this reason, as indicated by hatching in FIG. 7B, the flow of the liquid water is blocked by the lower protrusion portion 218.

The blocked liquid water flows downward along the communication flow path PA11 (FIG. 6A) of the dummy separator 12 and the front surface of the dummy assembly 11. Further, the liquid water is discharged to the outside of the cell stacked body 101 through the flow path PA6 (FIG. 1) for discharging the fuel gas. Accordingly, the liquid water in flow path PA1 can be suppressed from being guided to the anode flow path PAa of the power generation cell 1 beyond the through-hole 211 of the frame 21, and a stable power generation performance can be obtained.

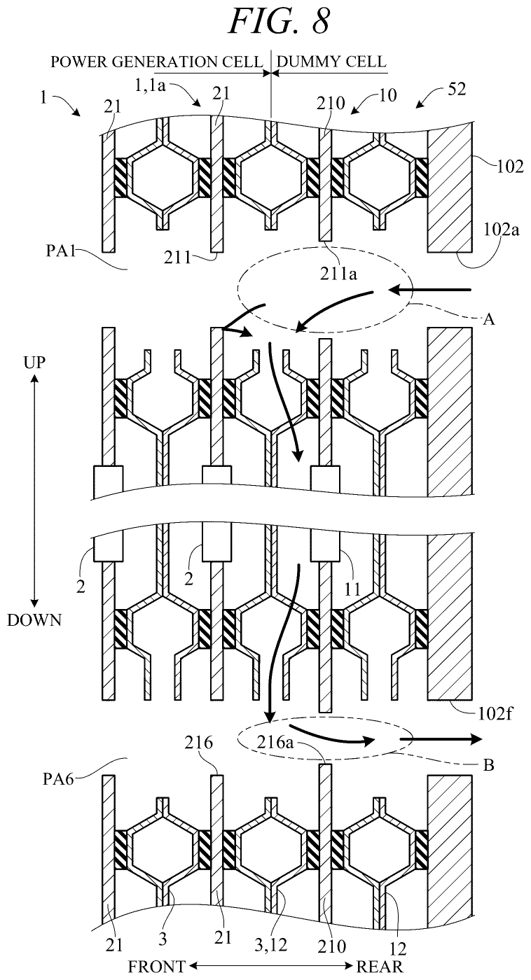

FIG. 8 is a view schematically illustrating a second example of the liquid water inflow suppressing portion, that is, a configuration of a second liquid water inflow suppressing portion 52, and is a cross-sectional view including the flow path PA1 for supplying the fuel gas and the flow path PA6 for discharging the fuel gas. Although not illustrated, the second liquid water inflow suppressing portion 52 is similarly provided also in the flow path PA4 for supplying the oxidant gas and the flow path PA3 for discharging the oxidant gas.

As illustrated in FIG. 8, the configuration of the flow path PA1 for supplying the fuel gas (the sizes of the through-holes 211 and 211a) is the same as that of the first liquid water inflow suppressing portion 51. Therefore, the through-hole 211a of the dummy frame 210 of the flow path PA1 is larger than the through-hole 211 of the frame 21 in the up-down direction.

On the other hand, in the flow path PA6 for discharge, the through-hole 216a of the dummy frame 210 is formed to be smaller (particularly smaller in the up-down direction) than the through-hole 216 of the frame 21 and smaller (particularly smaller in the up-down direction) than the through-hole 102f of the end unit 102. The through-hole 216 of the frame 21 and the through-hole 102f of the end unit 102 are the same size. Axes (not illustrated) of the through-holes 216 and 216a extending in the front-rear direction are positioned on the same straight line.

The second liquid water inflow suppressing portion 52 operates as follows. When the liquid water flows into the flow path PA1 through the through-hole 102a of the end unit 102, a part of the liquid water having passed through the through-hole 211a of the dummy frame 210 collides with the edge portion 217 (mainly the lower protrusion portion 218) of the through-hole 211 as indicated by an arrow in FIG. 8. The flow velocity and the pressure of the fuel gas are compared between a region A indicated by a two-dot chain line on the inlet side of the flow path PA1 and a region B indicated by a two-dot chain line on the outlet side of the flow path PA4. On the inlet side, the through-hole 211a is larger than the through-hole 211, so that the flow velocity is low and the pressure is high. On the other hand, on the outlet side, the through-hole 216a is smaller than the through-hole 216, so that the flow velocity is high and the pressure is low. Accordingly, a pressure difference between the region A and the region B increases, so that the flow of the liquid water from the region A to the region B is promoted and the liquid water in the flow path PA1 can be efficiently guided to the flow path PA6.

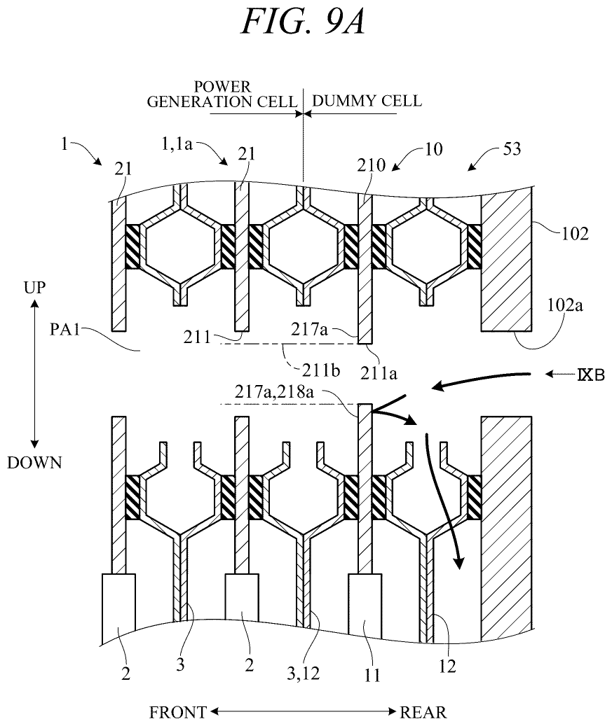

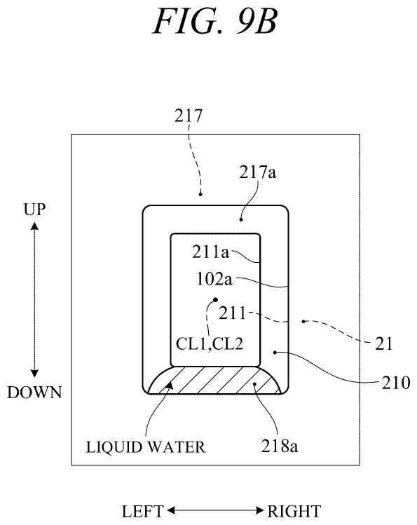

FIG. 9A is a view schematically illustrating a third example of the liquid water inflow suppressing portion, that is, a configuration of a third liquid water inflow suppressing portion 53, and FIG. 9B is a view (a view taken along an arrow IXB view of FIG. 9A) of the flow path PA1 when viewed from the rear. Although not illustrated, the third liquid water inflow suppressing portion 53 is similarly provided in the flow path PA4 for supplying the oxidant gas.

As illustrated in FIGS. 9A and 9B, contrary to the first liquid water inflow suppressing portion 51, in the third liquid water inflow suppressing portion 53, the through-hole 211a of the dummy frame 210 is formed to be smaller (particularly smaller in the up-down direction) than the through-hole 211 of the frame 21 and smaller than the through-hole 102a of the end unit 102. The through-hole 211 of the frame 21 and the through-hole 102a of the end unit 102 are the same size. The axis CL1 (FIG. 5) of the through-hole 211 and the axis CL2 (FIG. 5) of the through-hole 211a are positioned on the same straight line.

In the third liquid water inflow suppressing portion 53, an edge portion 217a of the through-hole 211a in the dummy frame 210 protrudes inward over the entire circumference of the edge portion 217 of the through-hole 211 in the frame 21. For this reason, the extension surface 211b obtained by extending the opening surface of the through-hole 211a forward is positioned inside the opening surface of the through-hole 211. The edge portion 217a of the through-hole 211a of the dummy frame 210 constitutes a protrusion portion protruding inward from the through-hole 211. The protrusion portion on the lower side is particularly referred to as a lower protrusion portion 218a.

The third liquid water inflow suppressing portion 53 operates as follows. When the liquid water flows into the flow path PA1 through the through-hole 102a of the end unit 102, a part of the liquid water collides with the edge portion 217a (mainly the lower protrusion portion 218a) of the through-hole 211a as indicated by an arrow in FIG. 9A. For this reason, as indicated by hatching in FIG. 9B, the flow of the liquid water is blocked by the lower protrusion portion 218a.

The blocked liquid water flows downward along the communication flow path PA11 (FIG. 6A) of the dummy separator 12 and the front surface of the end unit 102. Further, the liquid water is discharged to the outside of the cell stacked body 101 through the flow path PA6 (FIG. 1) for discharging the fuel gas. Accordingly, the liquid water in flow path PA1 can be suppressed from being guided to the anode flow path PAa of the power generation cell 1 beyond the through-hole 211a of the dummy frame 210, and a stable power generation performance can be obtained.

In the first liquid water inflow suppressing portion 51 and the second liquid water inflow suppressing portion 52 described above, a single dummy cell 10 is arranged between the power generation cell 1 and the end unit 102 (FIGS. 7A, 7B, and 8), but a plurality of (for example, two) dummy cells 10 may be arranged. In this case, the through-hole 211a of the front dummy frame 210 may be set to have the same size as the through-hole 211 of the frame 21 positioned in front of the front dummy frame 210, and may be smaller than the through-hole 211a of the rear dummy frame 210.

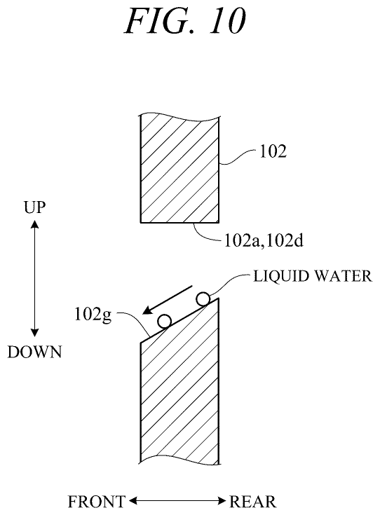

Accordingly, a part of the liquid water having passed through the through-hole 211a of the rear dummy frame 210 collides with the edge portion 217a around the through-hole 211a of the front dummy frame 210. As a result, similarly to the third liquid water inflow suppressing portion 53, the liquid water can be prevented from flowing forward beyond the through-hole 211a of the dummy frame 210 (rear dummy frame 210). FIG. 10 is a cross-sectional view illustrating a modification of through-holes 102a and 102d of the end unit 102 for supplying the reaction gas. In the modification of FIG. 10, the opening surfaces (particularly, lower opening surfaces) of the through-holes 102a and 102d of the end unit 102 are inclined downward such that the opening areas gradually increase toward the front. That is, an inclined surface 102g is provided on the opening surfaces (inner peripheral surfaces of the through-holes 102a and 102d) of the through-holes 102a and 102d. Accordingly, the liquid water flows obliquely downward along the inclined surface 102g, so that the flow of the liquid water to the dummy cell 10 on the front side is promoted, and the liquid water can be efficiently guided to the flow paths PA3 and PA6 for the reaction exhaust gas through the dummy cell 10.

According to the present embodiment, the following operations and effects are achievable.
(1) The fuel cell stack 100 includes a cell stacked body 101 and an end unit 102 (FIGS. 1 to 5). The cell stacked body includes the plurality of power generation cells 1 which are power generation elements stacked in a front-rear direction, and the dummy cell 10 which is a non-power generation element arranged adjacent to the rear end power generation cell 1a positioned at a rear end portion among the plurality of power generation cells 1, and in the cell stacked body 101, the flow paths PA1 and PA4 for gas supply into which a reaction gas is supplied and the flow paths PA3 and PA6 for gas discharge from which the reaction gas is discharged are provided to extend along the front-rear direction, and gas flow paths (anode flow path PAa, cathode flow path PAc) are provided to communicate the flow path PA1 with the flow path PA6 and the flow path PA4 with the flow path PA3. The end unit 102 is arranged adjacent to the dummy cell 10 and provided with a gas supply port (through-hole 102a, 102d) communicating with the flow paths PA1 and PA4 for gas supply and a gas discharge port (through-hole 102c, 102f) communicating with the flow paths PA3 and PA6 for gas discharge. The through-hole 211 (first communication hole) constituting the flow paths PA1 and PA4 for gas supply is opened in the rear end power generation cell 1a (frame 21), and the through-hole 211a (second communication hole) constituting the flow paths PA1 and PA4 for gas supply is opened in the dummy cell 10 (dummy frame 210) (FIGS. 7A to 9B). The fuel cell stack 100 includes any one of the first liquid water inflow suppressing portion 51, the second liquid water inflow suppressing portion 52, and the third liquid water inflow suppressing portion 53, and the through-hole 211 and the through-hole 211a are provided such that the extension surface 211b obtained by extending the opening surface of the through-hole 211a in the front-rear direction toward the through-hole 211 does not coincide with the opening surface of the through-hole 211 (FIGS. 7A, 8, and 9A).

With this configuration, liquid water (generated water or condensed water) having flowed into the flow paths PA1 and PA4 for gas supply together with the reaction gas can be caused to flow into the flow paths PA3 and PA6 for gas discharge through the inside of the dummy cell 10 before reaching the power generation cell 1. As a result, the supply of the liquid water to the power generation cell 1 can be suppressed, and a stable power generation performance can be obtained.
(2) In the first liquid water inflow suppressing portion 51 and the second liquid water inflow suppressing portion 52, the through-hole 211 of the frame 21 is smaller than the through-hole 211a of the dummy frame 210 (FIGS. 7A, 7B, and 8). Accordingly, the liquid water having flowed into the flow paths PA1 and PA4 for gas supply is blocked by the edge portion 217 of the through-hole 211 of the frame 21 of the rear end power generation cell 1a, and the liquid water can be suppressed from flowing into the flow paths PA1 and PA4 beyond the through-hole 211.
(3) In the second liquid water inflow suppressing portion 52, the through-holes 213 and 216 constituting the flow paths PA3 and PA6 for gas discharge are opened in the rear end power generation cell 1a (frame 21) (FIG. 3). In the dummy cell 10 (dummy frame 210), the through-holes 216a constituting the flow paths PA3 and PA6 for gas discharge and smaller than the through-holes 213 and 216 are opened (FIG. 8). Accordingly, a difference in pressure between the region A inside the through-hole 211a of the dummy frame 210 and the region B inside the through-hole 216a increases, and the liquid water before reaching the power generation cell 1 easily flows to the flow paths PA3 and PA6 for gas discharge.
(4) In the third liquid water inflow suppressing portion 53, the through-hole 211 of the frame 21 is larger than the through-hole 211a of the dummy frame 210 (FIGS. 9A and 9B). Accordingly, the liquid water having flowed into the flow paths PA1 and PA4 for gas supply is blocked by the edge portion 217a of the through-hole 211a of the dummy frame 210, and the liquid water can be suppressed from flowing into the flow paths PA1 and PA4 beyond the through-hole 211.
(5) The through-holes 102a and 102d (gas supply ports) for gas supply of the end unit 102 are provided with the inclined surfaces 102g having such a downward gradient that allows an opening area to gradually increase in the gas flow direction (FIG. 10). Accordingly, the liquid water flows obliquely downward along the inclined surface 102g, so that the flow of the liquid water to the dummy cell 10 on the front side is promoted, and the liquid water can be efficiently guided to the flow paths PA3 and PA6 for the exhaust gas through the dummy cell 10.
(6) The stacking direction of the fuel cell stack 100 is a substantially horizontal direction (front-rear direction) (FIG. 1). The vertical position of the lower end portion of the through-hole 211 of the frame 21 and the vertical position of the through-hole 211a of the dummy frame 210 are different from each other (FIGS. 7A, 7B, 8, 9A, and 9B). Accordingly, the reaction gas hits the edge portion 217 of the frame 21 of the rear end power generation cell 1a or the edge portion 217a of the dummy frame 210 of the dummy cell 10, and the liquid water contained in the reaction gas can be satisfactorily separated.
(7) The edge portion 217 or 217a of one of the through-hole 211 of the frame 21 and the through-hole 211a of the dummy frame 210 has a protrusion portion protruding into the opening region of the other of the through-hole 211 and the through-hole 211a when the through-holes 211 and 211a are viewed along the front-rear direction (FIGS. 7B and 9B). Accordingly, a part of the reaction gas having flowed into the flow paths PA1 and PA4 for gas supply hits the protrusion portion (edge portion 217 or 217a) before reaching the power generation cell 1, and the flow of the liquid water to the power generation cell 1 can be suppressed.
(8) The fuel cell stack 100 includes, as a part of the protrusion portion, the lower protrusion portion 218 or 218a provided at the edge portion of the lower end of one of the through-hole 211 and the through-hole 211a (FIGS. 7B and 9B). Accordingly, the liquid water flowing through the flow paths PA1 and PA4 for gas supply can be satisfactorily blocked.

The above embodiment can be modified in various forms. Below, some modified examples are described. In the above embodiment, the through-hole 211a (a second communication hole) of the dummy frame 210 in the gas supply flow paths PA1 and PA4 is provided so as to be larger or smaller in the up-down direction than the through-hole 211 (a first communication hole) of the frame 21, but the through-holes 211 and 211a may be provided so that the shapes of the through-holes 211 and 211a are different from each other while the sizes (an opening area) of the through-holes 211 and 211a are the same as each other. The through-holes 211 and 211a may be provided so that the positions of the axes CL1 and CL2 of the through-holes 211 and 211a may are different from each other while the sizes and shapes of the through-holes 211 and 211a are the same as each other. That is, as long as an extension surface formed by extending the opening surface of the second communication hole toward the first communication hole is misaligned with the opening surface of the first communication hole, the configurations of the first communication hole and the second communication hole are not limited to the above configurations.

In the above embodiment (FIG. 8), the through-hole 216a (a fourth communication hole) of the dummy frame 210 in the gas discharge flow paths PA3 and PA6 is provided so as to be smaller than the through-hole 216 (a third communication hole) of the frame 21, but as long as the third and fourth communication holes are provided so that the pressure in the region B is smaller, the configurations of the third and fourth through-holes are not limited to the above configurations. In the above embodiment, the through-holes 211 and 211a of the frame 21 and the dummy frame 210 are smaller than the through-hole 301 of the separator 3 and the dummy separator 12, and the through-hole 211 of the frame 21 is configured as the first communication hole of the power generation cell 1, and the through-hole 211a of the dummy frame 210 is configured as the second communication hole of the dummy cell 10. In this regard, the through-holes of the separator 3 and dummy separator 12 may be provided so that the through-holes 301 of the separator 3 and the dummy separator 12 are smaller than the through-holes 211 and 211a of the frame 21 and the dummy frame 210, and the through-hole 301 of the separator 3 is configured as the first communication hole, and the through-hole 301 of the dummy separator 12 is configured as the second communication hole.

In the above embodiment, a plurality of cells are stacked in the front-rear direction to form the cell stacked body 101, but the plurality of cells may be stacked in a predetermined direction other than the front-rear direction to form the cell stacked body. In this case, it is preferable that the stacking direction (the predetermined direction) is approximately horizontal. In the above embodiment, the dummy separator 12 adjacent to the end unit 102 is configured by the joint body of the front plate 3F and the rear plate 3R, similar to the separator 3, but it may be configured by a single plate (e.g., the front plate 3F), and thus the configuration of the dummy cell 10 is not limited to the above configuration. In the above embodiment, the through-holes 211 and 211a of the flow path PA1 for supplying fuel gas are configured to be approximately rectangular, but they may be configured to be convex downward.

The above embodiment can be combined as desired with one or more of the above modifications. The modifications can also be combined with one another.

According to the present invention, it is possible to suppress liquid water contained in a reaction gas supplied through a gas supply port from flowing into a power generation cell, thereby obtaining stable power generation performance.

Above, while the present invention has been described with reference to the preferred embodiments thereof, it will be understood, by those skilled in the art, that various changes and modifications may be made thereto without departing from the scope of the appended claims.

What is claimed is:

1. A fuel cell stack comprising:
a cell stacked body including a plurality of power generation cells stacked in a predetermined direction, a dummy cell, a gas supply flow path into which a reaction gas is supplied, a gas discharge flow path through which the reaction gas is discharged, and a gas flow path communicating the gas supply flow path and the gas discharge flow path, the plurality of power generation cells including an end power generation cell disposed at an end in the predetermined direction, each of the plurality of power generation cells being a power generation element, the dummy cell being disposed adjacent to the end power generation cell and being a non-power generation element, the gas supply flow path and the gas discharge flow path extending along the predetermined direction; and
an end unit disposed adjacent to the dummy cell, wherein
a gas supply port communicating with the gas supply flow path and a gas discharge port communicating with the gas discharge flow path are provided at the end unit,
the gas supply flow path is configured by a plurality of communication holes including a first communication hole provided at the end power generation cell and a second communication hole provided at the dummy cell, and
the first communication hole and the second communication hole are arranged such that an extension surface formed by extending an opening surface of the second communication hole in the predetermined direction toward the first communication hole is misaligned with an opening surface of the first communication hole.

2. The fuel cell stack according to claim 1, wherein
the first communication hole is smaller than the second communication hole.

3. The fuel cell stack according to claim 2, wherein
the gas discharge flow path is configured by a plurality of communication holes including a third communication hole provided at the end power generation cell and a fourth communication hole provided at the dummy cell, and
the fourth communication hole is smaller than the third communication hole.

4. The fuel cell stack according to claim 1, wherein
the first communication hole is larger than the second communication hole.

5. The fuel cell stack according to claim 1, wherein
the end unit includes an inclined surface formed on an opening surface of the gas supply port in a manner of a downward gradient so that an opening area of the gas supply port gradually increases along a flow direction of the reaction gas.

6. The fuel cell stack according to claim 1, wherein
the predetermined direction is a substantially horizontal direction, and
a position in an up-down direction of a lower edge of the first communication hole is different from a position in the up-down direction of a lower edge of the second communication hole.

7. The fuel cell stack according to claim 1, wherein
an edge of one of the first communication hole and the second communication hole includes a protrusion portion protruding into an opening area of another of the first communication hole and the second communication hole in a state that the first communication hole and the second communication hole are viewed along the predetermined direction.

8. The fuel cell stack according to claim 7, wherein
the predetermined direction is a substantially horizontal direction, and
the protrusion portion is provided at a lower edge of the one of the first communication hole and the second communication hole.

9. The fuel cell stack according to claim 1, wherein
a first axial line extending in the predetermined direction through a center of the first communication hole and a second axial line extending in the predetermined direction through a center of the second communication hole are aligned on a same straight line.

10. The fuel cell stack according to claim 1, wherein
each of the plurality of power generation cells includes a unitized electrode assembly and a pair of separators disposed on both sides in the predetermined direction of the unitized electrode assembly, the unitized electrode assembly including a membrane electrode assembly configured as a joint body of an electrolyte membrane and an electrode and a frame supporting the membrane electrode assembly,
the dummy cell includes a dummy assembly and a pair of dummy separators disposed on both sides in the predetermined direction of the dummy assembly, the dummy assembly including a dummy joint body and a dummy frame supporting the dummy joint body, and
the pair of separators and the pair of dummy separators are configured to have a same shape.
